(19) United States
(12) Patent Application Publication
(10) Pub. No.: US 2012/0287015 A1
(43) Pub. Date: Nov. 15, 2012

(54) MULTI-LAYER ANTENNA

(75) Inventors: CHO-JU CHUNG, Tu-Cheng (TW); AI-NING SONG, Shanghai (CN)

(73) Assignees: HON HAI PRECISION INDUSTRY CO., LTD., Tu-Cheng (TW); AMBIT MICROSYSTEMS (SHANGHAI) LTD., SHANGHAI (CN)

(21) Appl. No.: 13/449,293

(22) Filed: Apr. 17, 2012

(30) Foreign Application Priority Data
May 11, 2011 (CN) 201120148427.8

(51) Int. Cl. H01Q 1/38; H01Q 21/00

(52) U.S. Cl. 343/893; 343/700 MS

(57) ABSTRACT

A multi-layer antenna comprising a plurality of antenna units disposed on a multi-layer printed circuit board (PCB). Each layer of the multi-layer PCB respectively comprises two antenna units along two conjoined edges of the layer. Each antenna unit comprises a feeding portion and a radiating portion. The feeding portion is operable to feed received electromagnetic wave signals to the antenna unit. The radiating portion is operable to radiate the electromagnetic wave signals, and comprises a first radiating part and a second radiating part. The first radiating part is rectangular, and a first end of the first radiating part connects to the feeding portion while a second end of the first radiating part connects to the second radiating part. The second radiating part extends away from the first radiating part and forms a meandering “S” pattern.

### BACKGROUND

1. Technical Field

The present disclosure relates to antennas, and more particularly to a multi-layer antenna.

2. Description of Related Art

Wireless communication technologies allow mobile communication products integrated with communication modules to not only communicate with local area networks and transmit e-mails, but also receive real-time information such as news and stock information.

An antenna is a key component of each mobile communication product. Miniaturization design on the antenna is essential for volume reduction to a smaller-size mobile communication product. Thus, a smaller and less intrusive fitted antenna provides a better user experience.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 shows a schematic view of an embodiment of a structure of a multi-layer antenna in accordance with the present disclosure.

FIG. 2 shows a schematic view of an embodiment of a structure of a first antenna unit in accordance with the present disclosure.

FIG. 3 shows a schematic view of an embodiment of an exemplary structure of the first antenna unit with designated sizes shown in FIG. 2 in accordance with the present disclosure.

FIG. 4 shows exemplary return loss measurement for the multi-layer antenna shown in FIG. 1 in accordance with the present disclosure.

FIG. 5 shows a schematic view of antenna radiation pattern on the X-Y plane of the multi-layer antenna shown in FIG. 1 in accordance with the present disclosure.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

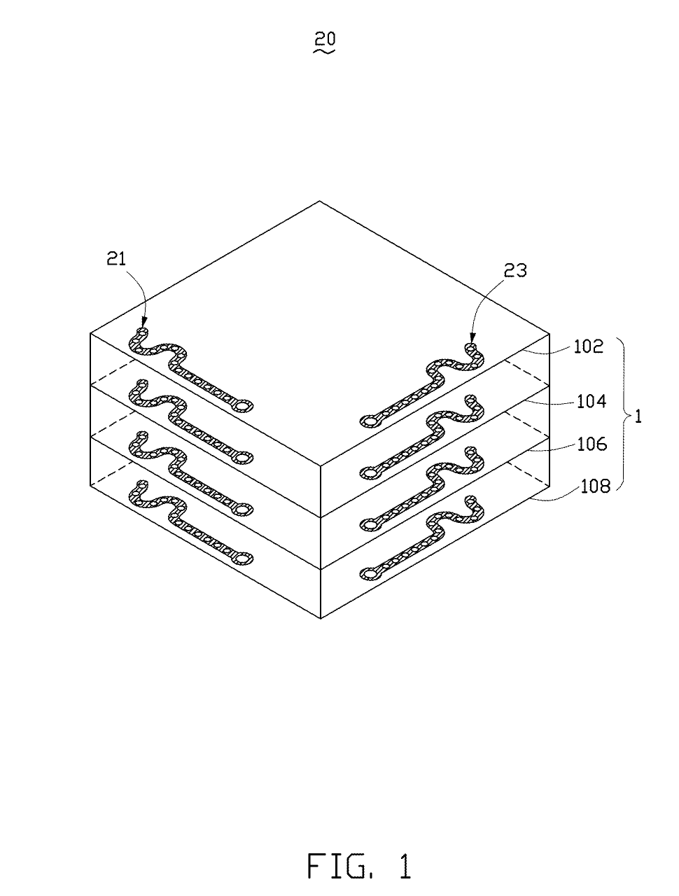

FIG. 1 shows a schematic view of an embodiment of a structure of a multi-layer antenna 20 in accordance with the present disclosure.

In the present embodiment, the multi-layer antenna 20 includes a plurality of antenna units disposed on a multi-layer printed circuit board (PCB). Each layer of the multi-layer PCB comprises two of the plurality of antenna units which are respectively disposed on two conjoined edges of the layer. In the present embodiment, for example, the multi-layer antenna 20 is composed of four layers of PCBs, a first layer 102, a second layer 104, a third layer 106, and a fourth layer 108. Two antenna units, such as a first antenna unit 21 and a second antenna unit 23, are disposed on each of the layers 102, 104, 106 and 108 of the PCBs. In the present embodiment, the shape and size of the first antenna unit 21 is identical to those of the second antenna unit 23 and the locations of each of the antenna units 21 and 23 on each layer of the PCB are identical.

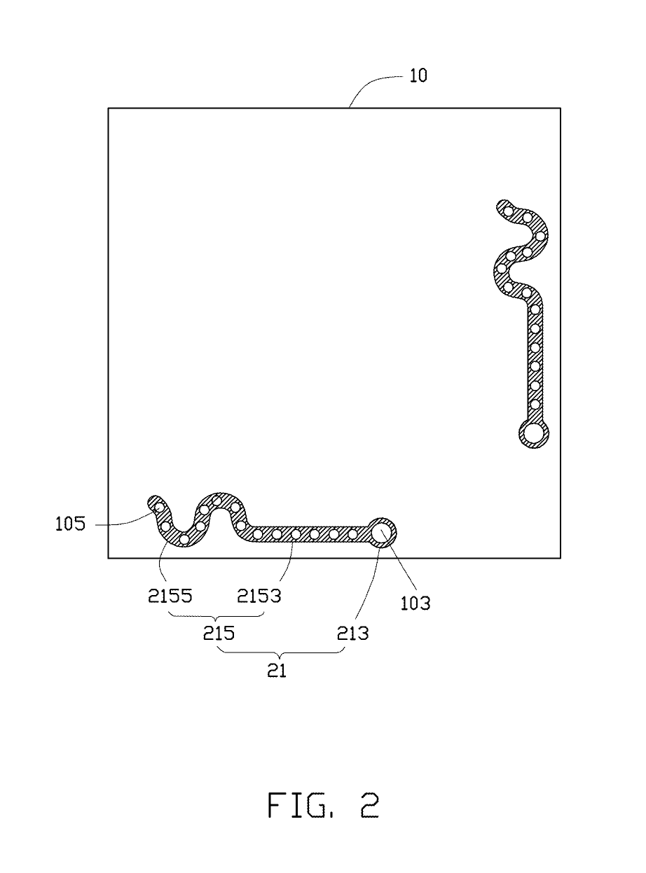

FIG. 2 shows a schematic view of an embodiment of a structure of the first antenna unit 21 in accordance with the present disclosure.

In the present embodiment, each first antenna unit 21 includes a feeding portion 213 and a radiating portion 215.

Each feeding portion 213 is a circular metal pad printed on a layer of the multi-layer PCB. The feeding portions 213 of the first antenna units 21 are printed on the layers 102, 104, 106, and 108 of the multi-layer PCB. In the present embodiment, a first via 103 is defined at the center of the feeding portion 213 to connect the feeding portion 213 of the first antenna unit 21 on the layer 102 to those of the layers 104, 106, and 108. Each feeding portion 213 can distribute received electromagnetic wave signals through the first via 103 to other feeding portions of other layers of the multi-layer PCB. In the present embodiment, defining a via at the feeding portion 213 enables impedance matching and improves radiation pattern of the multi-layer antenna 20 vertically where the PCB layers are horizontal.

The radiating portion 215 used for radiating electromagnetic wave signals includes a first radiating part 2153 and a second radiating part 2155. In the present embodiment, the first radiating part 2153 and the second radiating part 2155 include metal micro-strips printed on each layer of the PCB. In addition, a plurality of smaller second vias 105 are defined at equal intervals on the metal micro-strips, thereby increasing radiating bandwidth of the multi-layer antenna 20. Each of the second vias 105 electrically connects the radiating portion 215 with corresponding radiating portions 215 on the layers 102, 104, 106, and 108. An aperture size of the first via 103 is greater than aperture size of the second via 105.

The first radiating portion 2153 is bar-shaped. A first end of the first radiating part 2153 is electrically connected to the feeding portion 213, while a second end of the first radiating part 2153 is connected to the second radiating part 2155. The bar-shaped first radiating part 2153 is parallel to an edge of a substrate 10. In the present embodiment, the first radiating part 2153 serves as a radiating portion with highly concentrated current density.

The second radiating part 2155 extends away from the first radiating part 2153 and snakes, or meanders in an “S” shape. The second radiating part 2155 serves as a radiating portion with low current density. The adverse impact on radiating performance associated with miniaturization of the multi-layer antenna 20 is thus significantly ameliorated.

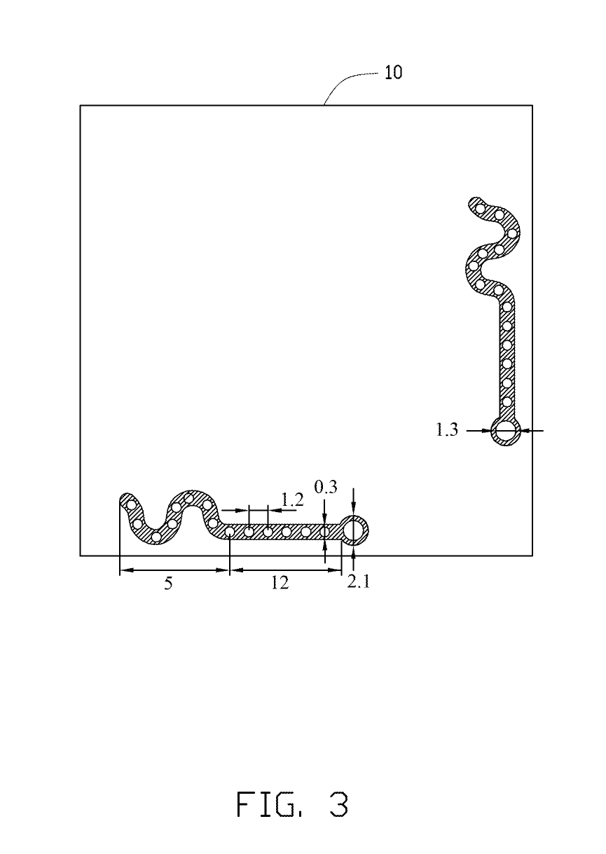

FIG. 3 shows a schematic view of an exemplary structure of the first antenna unit 21 with designated sizes in millimeters (mm) in accordance with the present disclosure. As shown in FIG. 3, the internal and external diameters of the feeding portion 213 are 1.3 mm and 2.1 mm, respectively. The diameter of the first via 103 is 1.3 mm, the diameter of the second via 105 is 0.3 mm, and the distance between two vias 105 is 1.2 mm. In addition, the antenna unit 21 is a monopole antenna, which is λ/4 in length. The λ represents wavelength of the electromagnetic signals transmitted and received by the multi-layer antenna 20.

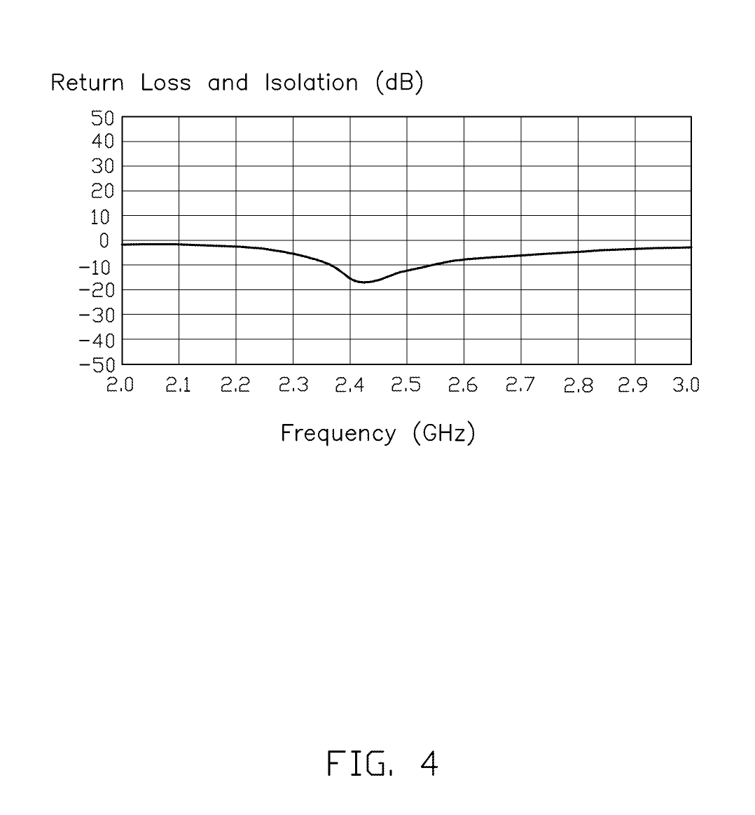

FIG. 4 shows exemplary return loss measurement for the multi-layer antenna 20 shown in FIG. 1 in accordance with the present disclosure. As shown in FIG. 4, the multi-layer antenna 20 is designed as a multi-layer structure and the antenna unit disposed on each layer is composed partly of an S-shape and partly of a rectangular shape, so that the multi-layer antenna 20 can cover radio frequency bands 2.4 GHz-2.5 GHz over which return loss attenuation is less than −10 decibels (dB), which is applicable to communication standards.

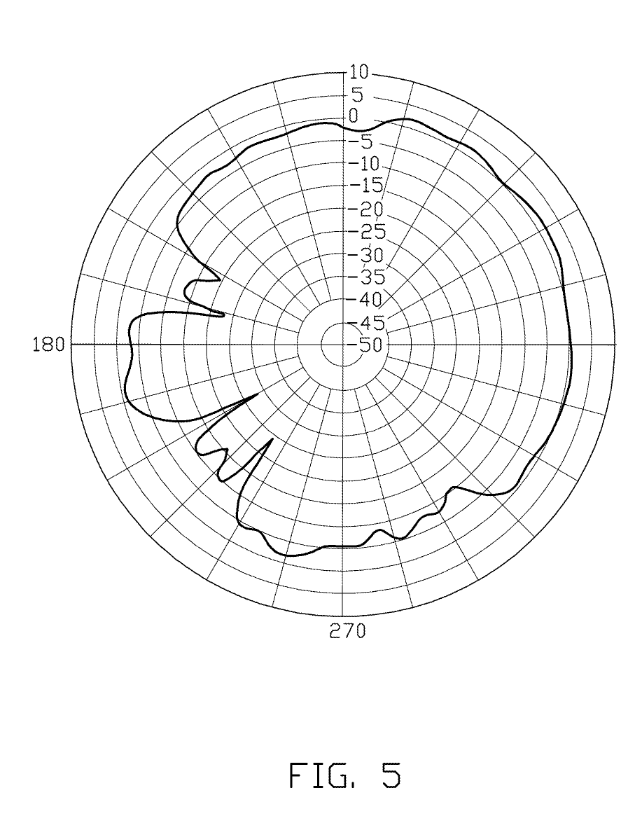

FIG. 5 shows a schematic view of antenna radiation pattern on the X-Y plane of the multi-layer antenna 20 shown in FIG. 1 in accordance with the present disclosure. As shown in FIG. 5, the antenna radiation pattern on the X-Y plane of the multi-layer antenna 20 is working within the 2.4 GHz-2.5 GHz bands which are applicable to communication standards.

The multi-layer antenna 20 of the present disclosure is designed as a multi-layer structure and each layer is connected through vias. Antenna units are disposed on layers and are composed partly of an S-shape and partly of a rectangular shape. Therefore, antenna dimensions can be reduced and radiating performance of the multi-layer antenna 20 is greatly enhanced.

Although the features and elements of the present disclosure are described as embodiments in particular combinations, each feature or element can be used alone or in other combinations within the principles of the present disclosure to the full extent indicated by the broad general meaning of the terms in which the appended claims are expressed.

What is claimed is:

1. A multi-layer antenna comprising a plurality of antenna units disposed on a printed circuit board (PCB) that comprises multiple layers, each of the multiple layers comprising two antenna units of the plurality of antenna units that are respectively disposed by two neighboring edges of the layer, each of the antenna units comprising:
a feeding portion operable to feed electromagnetic wave signals to the antenna unit; and
a radiating portion operable to radiate the electromagnetic wave signals, and comprises a first radiating part and a second radiating part, wherein the first radiating part is is rectangular, a first end of the first radiating part connects to the feeding portion, a second end of the first radiating part connects to the second radiating part, the second radiating part extends along a direction away from the first radiating part.

2. The multi-layer antenna as claimed in claim 1, wherein the feeding portion is a circular metal pad and printed on one layer of the PCB.

3. The multi-layer antenna as claimed in claim 2, wherein a first via is defined at the center of the feeding portion.

4. The multi-layer antenna as claimed in claim 3, wherein two feeding portions of two different antenna units disposed on two different layers of the PCB are connected through the first via.

5. The multi-layer antenna as claimed in claim 4, wherein the first radiating part and the second radiating part comprises metal micro-strips printed on one layer of the PCB.

6. The multi-layer antenna as claimed in claim 5, wherein a plurality of second vias are defined by equal intervals on the metal micro-strips.

7. The multi-layer antenna as claimed in claim 1, wherein an aperture size of the first via is greater than an aperture size of the second via.

8. The multi-layer antenna as claimed in claim 1, wherein the radiating portions of each layer of the PCB are connected through the second vias.

9. The multi-layer antenna as claimed in claim 1, wherein the second radiating part is formed in a meandering pattern.
